(19) United States
(12) Patent Application Publication
(10) Pub. No.: US 2026/0300262 A1
(43) Pub. Date: Oct. 1, 2026

(54) ALLOWING UPDATABLE VIEWS TO SPECIFY COLUMN VALUES TO BE USED FOR UPDATE OR INSERT WITHOUT REQUIRING THE COLUMN TO BE VISIBLE TO THE VIEW

(71) Applicant: Oracle International Corporation, Redwood Shores, CA (US)

(72) Inventor: Allan George Schrum, Bozeman, MT (US)

(21) Appl. No.: 19/096,172

(22) Filed: Mar. 31, 2025

(51) Int. Cl. G06F 16/23; G06F 16/26; G06F 21/62

(52) U.S. Cl. CPC G06F 16/2365; G06F 16/26; G06F 21/6218

(57) ABSTRACT

Innovative security is imposed on a database view in a relational database to ensure semantic integrity of database columns, some of which may be restricted columns that can be hidden, read only, referential, or value constrained. A computer hosts a database management system (DBMS) that generates a database view based on a data definition language (DDL) statement that specifies a value expression for a restricted column in the base table. A data manipulation language (DML) statement executes, which entails dynamic and innovative generation of values. Evaluating the value expression generates a new value for the base table. The new value is then stored into the restricted column in the base table. View initialization can be entirely confined to that single DDL statement. This approach does not use a database trigger and supports, but does not require, an ALTER DDL statement or a data control language (DCL) statement.

### FIELD OF THE DISCLOSURE

This disclosure relates to imposing security on a database view in a relational database to ensure semantic integrity of database columns, some of which may be restricted columns that can be hidden, read only, referential, or value constrained.

### BACKGROUND

As the use of databases increases, so do the use cases where database views are exposed to applications without exposing the underlying base tables used for storage. Database views often provide horizontally (i.e. filtered) or vertically sliced views of base tables to provide application-level access consistent with a designed data interface to be supported by the database for an application. A database view may, for example, provide a legacy interface that is a stable interface to base table(s) that can change schematically. Often applications only access views for all purposes and never access base tables at all.

While a state of the art database view is powerful in those ways, the database view itself is designed according to an application-specific tradeoff between security (e.g. privacy and data integrity) and functionality. For example, if a database view has no application-specific purpose for a column in a base table, then the view could be defined without that base column, which increases security. However, such omission of a column from a view definition may greatly curtail the functionality of the view. For example, a new row cannot be inserted through the view if an omitted column is a foreign key or lacks a default value. Likewise, a view column of an existing row should not be revised if the omitted column should be revised when the view column is revised. If a functionality (e.g. update or insert) is required of the view, then some columns that could be omitted for security are instead included, by the state of the art, in the view definition. Such relaxation of security is only to increase the functionality of the view. That is a design tension between security and functionality.

Here are some examples of how an accidentally or maliciously invalid write to a database can disrupt operations. Inserting invalid or inconsistent data through a database view can cause applications to malfunction or produce incorrect results. Invalid data can cause errors or exceptions that cause applications to fail or become unresponsive. System failures and data corruption can lead to significant operational downtime, impacting business processes and productivity. A malicious writes might be used to gain unauthorized access to the database or other systems. Sensitive information, such as passwords, credit card numbers, or personal data, can be stolen and misused. Data breaches and security incidents can damage an organization's reputation and lead to loss of customer trust.

To mitigate these risks, the following are state of the art security measures. Validating and sanitizing user input can prevent malicious data injection. Security audits can identify and address vulnerabilities. Monitoring database activity for suspicious behavior and logging all access attempts helps prevent or discover data risks. Maintaining regular backups facilitates recovery from data loss.

### BRIEF DESCRIPTION OF THE DRAWINGS

In the drawings:

FIG. 1 is a block diagram that depicts an example database management system (DBMS) that imposes security on a database view in a relational database to ensure semantic integrity of view columns, even if some view columns are restricted columns such as hidden, read only, referential, or value constrained;

FIG. 2 is a flow diagram that depicts an example computer process that a DBMS may perform to impose security on a database view in a relational database to ensure semantic integrity of view columns, even if some view columns are restricted columns such as hidden, read only, referential, or value constrained;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Herein, innovative security is imposed on a database view in a relational database to ensure semantic integrity of database columns, some of which may be restricted columns that can be hidden, read only, referential, or value constrained. The base table of this database view is updatable according to schematic rules associated with the database engine. Schematic rules may restrict access or constrain values. Herein, a schematic rule is also referred to as a restriction. All columns of a base table of a state of the art database view must be exposed in the view so that structured query language (SQL) INSERT statements can reference the columns to provide values for columns that do not have a default value. Herein, specification and creation of a database view includes metadata for supplying values to restricted columns not or incompletely exposed by the view even when these columns are required to fulfill INSERT or UPDATE data manipulation (DML) statements using the view.

Because initialization can be entirely confined to a CREATE VIEW data definition language (DDL) statement, this approach does not use a database trigger and supports, but does not require, an ALTER DDL statement or a data control language (DCL) statement. In an embodiment, the database view is unmaterialized and operates as a direct pass through of data into a base table for either: a) an update through any view column in the database view or b) insertion of a new view row through the database view. This approach is a new way to dynamically generate implied values for columns unmentioned in an UPDATE or INSERT DML statement. Implied values herein: a) ensure semantic integrity such as value ranges and referential integrity and b) increase access control and information hiding for security concerns such as privacy, tamper resistance, and accidental data loss.

Update of existing values and insertion of a new row are two storage activities that each may have its own separate automation for generating implied values. These two storage activities are decoupled from each other such that an embodiment may, for example, implement only insertion or only update. This approach is noninvasive because it supports, but does not require, a change to base tables nor to content already stored.

### 1.0 Example Database Management System (DBMS)

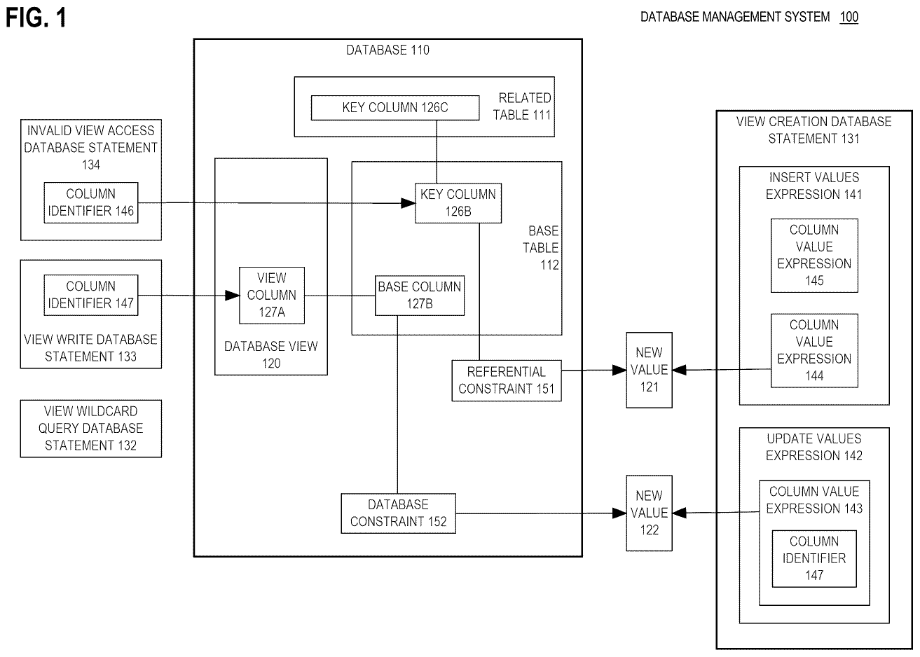

FIG. 1 is a block diagram that depicts example database management system (DBMS) 100 that imposes security on database view 120 in database 110 to ensure semantic integrity of database columns 126B, 127A, and 127B, even if some database columns are restricted columns such as hidden, read only, referential, or value constrained. All of the components shown in FIG. 1 may be stored and operated in respective volatile or nonvolatile storage in a computer that hosts DBMS 100. The computer may, for example, be one or more of a rack server such as a blade, a mainframe, or a virtual machine.

Database 110 is a relational database operated by DBMS 100. Database 110 contains multiple database tables 111-112 that consist of table rows and table columns. Database 110 initially does not, but eventually will, contain database view 120 that is backed by exactly one base table 112. Data structures 111-112 and 120 are tabular data structures that consist of multiple structural rows, multiple structural columns, and multiple values. Each value is stored in one column in one row.

### 1.1 Database View

Each value that is logically in database view 120 corresponds to a respective one value that is stored in corresponding base table 112. In an embodiment, database view 120 is an innovatively enhanced structured query language (SQL) view. Database view 120 is unmaterialized and does not store values. Database view 120 instead operates as a direct (i.e. synchronous, immediate) pass through of data to and/or from base table 112. In an embodiment, base table 112 has fewer access restrictions, if any, than database view 120 has. Unless otherwise configured as discussed later herein, database view 120 cannot be used to avoid access restrictions and security restrictions of base table 112.

As discussed below, create, read, update, and delete (CRUD) are storage actions, some of which some embodiments of database view 120 do not support even if supported by base table 112. In an embodiment after creating database view 120, contents of base table 112 may change without using database view 120, and database view 120 subsequently can reflect these changes. For example, database view 120 cannot be used to read: a) a previous value that was updated in base table 112 nor b) a value in a row that was deleted in base table 112.

Herein are two complimentary (i.e. combinable) embodiments of database view 120 that are distinguished from each other by how contents of base table 112 can be changed through database view 120. In an insert embodiment of database view 120, insertion of a new view row into database view 120 causes insertion of a corresponding new table row into base table 112. Database view 120 is unmaterialized, and rows and values are instead stored in base table 112.

In an update embodiment of database view 120, values in at least one view column are individually updatable, which revises the stored value in the base table 112. Database view 120 comprises one or both of the update embodiment and the insert embodiment. For example, some embodiments of database view 120 may lack or incompletely support one but not both of: a) inserting a new base table row through database view 120 or b) updating, through database view 120, an existing row in base table 112.

As discussed above, CRUD are storage actions that operate on base tables either directly or indirectly (i.e. through database view 120). In other words, a storage action is direct or indirect. Herein, a view expression is not a storage action and, instead, is an innovative way in which database view 120 performs an indirect storage action. The purpose of a view expression is privacy and/or integrity of data, both of which are database security concerns. A view expression is an innovative database security technique that prevents exposure, discovery, exfiltration, accidental loss, and tampering of data in database tables 111-112.

### 1.2 View Creation Statement

Depending on the embodiment, view creation database statement 131 has one or both of view values expressions 141-142 that, when later evaluated for a new or existing view row, dynamically generate value(s), with each value to be written through a respective view column in database view 120. Before database view 120 exists, DBMS 100 receives or generates view creation database statement 131 that contains a definition of database view 120. Execution of view creation database statement 131 causes generation of a definition of database view 120 and view column 127A in a database dictionary of database 110.

There is a direct correspondence between one view column 127A and one base column 127B, and this direct correspondence of two columns is specified expressly or impliedly in view creation database statement 131.

Execution of view creation database statement 131 does not indirectly nor directly write to any of database tables 111-112. Immediately after execution of view creation database statement 131, view values expressions 141-142 remain unevaluated because an evaluation result value is not needed until view write database statement 133 later executes. One of view values expressions 141-142 is dynamically and separately evaluated for each row written to database view 120 by executing database statement 133.

Which one of view values expressions 141-142 is evaluated when executing view write database statement 133 depends on what storage action is specified in view write database statement 133. If view write database statement 133 specifies updating, then update values expression 142 is evaluated. If inserting is instead specified, then insert values expression 141 is evaluated. If an upsert (i.e. update and insert) is specified, then: a) each view row written is individually either an updated row or an inserted row, and b) which of view values expressions 141-142 is evaluated depends on the respective storage action (i.e. update or insert) for the view row.

### 1.3 View Write Statement

Herein, a view column restriction is an access (i.e. storage action) restriction that is defined for a view column but not defined for the corresponding base column. For example, a base column may have no access restriction, and a view column restriction on the corresponding view column may forbid reading the view column, or writing, but not both. Because key column 126B is hidden (i.e. unexposed), it has no corresponding view column. A database client cannot use database view 120 to read or discover key column 126B. In an embodiment, view access database statement 133 should not reference key column 126B and does not specify a value nor value expression for key column 126B.

View write database statement 133 can update existing base rows or insert new base rows through database view 120. For each base row being written, there is one evaluation of one of view values expressions 141-142, and that one evaluation may read and write multiple base columns in that base row, and view column restrictions are not enforced for view values expressions 141-142. For example, insert values expression 141 has full access to key column 126B that may be a hidden (i.e. unexposed) base column and, as discussed below, also has access to read-only view columns and write-only view columns in database view 120, so long as corresponding base components 112 and 126B or 127B permit such access.

In an embodiment, some or all of view statement components 133 and 141-142 are, for some storage actions or some base columns, provided unrestricted or less restricted access to either or both of base components 112 and 126B or 127B. In that case, a client has less-restricted indirect access than direct access to base components 112 and 126B or 127B. For example, base table 112 may be inaccessible to a client except through database view 120.

Database view 120 contains multiple view columns that may be a mix of view columns where each column is writeable, readable, or both. Herein, a write is either: a) an insert of at least one new view row into database view 120 or b) an update that stores a respective revised value into each of at least one view column in at least one existing view row in database view 120. Here, (b) entails overwriting a previous value, and (a) does not. Database view 120 is not read only, which means that database view 120 supports view value update or view row insert or both.

Executing view write database statement 133 causes storing, into base column 127B, new value 122 from column value expression 143. In a preferred embodiment, database view 120 is unmaterialized such that database view 120 operates as a direct pass through of data into database table 112 for any of: a) an update through any view column in database view 120 or b) insertion of a new view row through database view 120.

Insert values expression 141 contains column value expressions 144-145 respectively for base columns 126B-127B. One-to-one association of a distinct base column to a distinct column value expression in insert values expression 141 is positional as follows. Base columns 126B-127B are a sequence originally explicitly ordered by a table creation DDL statement (not shown). Column value expressions 144-145 are an explicit sequence in insert values expression 141. Thus, there are a sequence of base columns 126B-127B and a sequence of column value expressions 144-145. These two sequences have a same length, and a same offset (i.e. position) may positionally identify a base column and its corresponding column value expression in insert values expression 141.

Update values expression 142 contains at most as many column value expressions 143 as base columns 126B-127B or as few as one column value expression 143 even though base table 112 contains multiple base columns 126B-127B. Each column value expression 143 contains the distinct column identifier (e.g. name) of one of respective base columns 126B-127B and, in this example, same column identifier 147 is contained in both data structures 133 and 143, which causes storage of new value 122 into base column 127B.

### 1.5 Explicit Semantic Invariants for Data Integrity

Database constraints 151-152 are value constraints on respective base columns 126B-127B. A database constraint is an invariant condition of database content as guaranteed by DBMS 100 For example, database constraint 152 may forbid storing new value 122 when null. For an equijoin on a relationship between database tables 111-112, key columns 126B-126C respectively are a foreign key and a primary key. Foreign key column 126B is a referential column that may, for example, be access restricted or value constrained.

Referential constraint 151 requires key column 126C contains new value 121 that column value expression 144 generated. Herein, a restricted column is a base column that: a) has a corresponding value constraint such as database constraints 151-152 or b) is access restricted (i.e. hidden, read only, or write only) either expressly by the definition of base table 112 or implicitly by a similar view access restriction on the corresponding view column. For example if view column 127A is read only or write only then, herein, base column 127B is a restricted column. A hidden column, such as key column 126B, is a restricted column because key column 126B has no corresponding view column.

### 1.6 Exemplary View Creation Statement

The following is an exemplary view creation database statement 131 that is nonstandard SQL that generates database view 120 that may be somewhat different from as shown in FIG. 1.

```
CREATE VIEW MGRS AS
SELECT e.FIRST_NAME, e.LAST_NAME
FROM EMPLOYEES e, JOBS j
WHERE e.JOB_ID = j.JOB_ID AND j.JOB_ID = ‘MANAGER’
ON INSERT SET
  e.JOB_ID = ‘MANAGER’,
  e.FULL_NAME = FIRST_NAME+‘ ’+ LAST_NAME
ON UPDATE SET e.FULL_NAME = FIRST_NAME+‘ ’+
LAST_NAME;
```

The following terms have the following meanings in the above exemplary view creation database statement 131. The above FROM clause has multiple database tables for an equijoin in the WHERE clause. In the above exemplary statement, EMPLOYEES is base table 112, and JOBS is related table 111.

The above SELECT clause is a projection clause that exposes two view columns. Key column 126B is hidden table column e.FULL_NAME, and it cannot be read nor discovered by a client of database view 120, and the client cannot cause storage of a FULL_NAME value that lacks a space character (i.e. ‘ ’).

The above exemplary statement may omit either one, but not both, of the ON UPDATE and the ON INSERT clauses. A period character (i.e. ‘·’) is a separator character that separates a table identifier from a column identifier. For example, e.JOB_ID is a base column in the EMPLOYEES table. A column identifier without a table identifier is a reference to a new value currently being written through database view 120 but, as discussed below, this new value is neither of new values 121-122. Above SQL expression “e.FULL_NAME=FIRST_NAME+‘+’+LAST_NAME” is both of column value expressions 143 and 145. Above SQL expression “e.JOB_ID=‘MANAGER’” is column value expression 144.

### 1.7 Exemplary View Update Statement

For example, FIRST_NAME+‘ ’+LAST_NAME entails concatenation of two new values that are not generated by view values expressions 141-142. Those two new values instead are generated by evaluating write value expressions (not shown) contained in view write database statement 133. For example, a write value expression may contain column identifier 147. The following is an exemplary view write database statement 133 that is a standard SQL UPDATE statement that is compatible with the above exemplary view creation database statement 131.

UPDATE EMPLOYEES SET FIRST_NAME = ‘John’ AND
LAST_NAME = ‘Doe’
WHERE FIRST_NAME = ‘Joe’ AND LAST_NAME = ‘Lunchbox’;

### 2.0 Example Database View Integrity Process

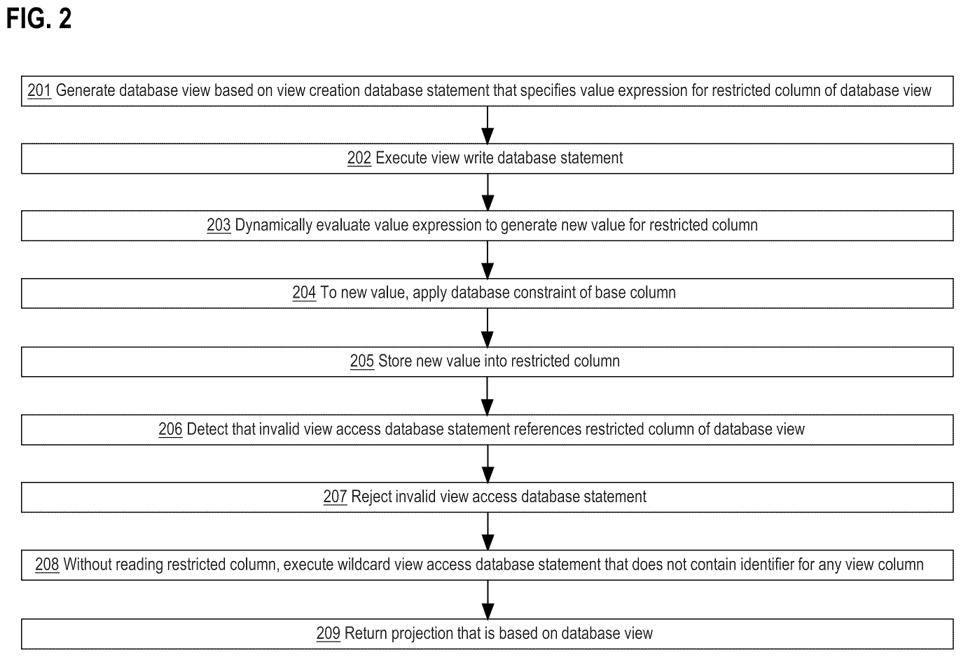

FIG. 2 is a flow diagram that depicts an example computer process that database management system (DBMS) 100 may perform to impose security on database view 120 in database 110 to ensure semantic integrity of base columns 126B-127B, even if some base columns are restricted columns such as hidden, read only, referential, or value constrained. For demonstration, the process of FIG. 2 performs three example scenarios A-C as follows. Scenarios A-C can be performed without using a database trigger.

### 2.1 View Integrity Scenario A: Dynamic Generation of Implied Value

Scenario A entails steps 201-205 that create database view 120 and write value(s) through database view 120 into base table 112. Step 201 generates database view 120 by: a) generating or receiving view creation database statement 131 that specifies column value expression 144 for key column 126B that is a base column that is a restricted column, and b) executing view creation database statement 131. Because scenario A lacks a database trigger, herein none, one, or both of the following invariants can occur for the entire duration between steps 201-202: a) database view 120 is schematically unaltered, and b) no data definition language (DDL) statement is applied to database view 120.

Step 202 entails: a) generating or receiving view write database statement 133 and b) executing view write database statement 133. Scenario A satisfies any constraints, restrictions, and policies of database 110, which means that scenario A succeeds as follows. Steps 203-205 are sub-steps of step 202.

Step 203 dynamically evaluates a column value expression to generate a new value for a restricted column. In an example where scenario A inserts a new row through database view 120 into base table 112, new value 121 is generated by evaluation of column value expression 144 in step 203. In an example where scenario A overwrites existing values in some base column(s) and some base row(s) through database view 120, new value 122 is generated by evaluation of column value expression 143 in step 203.

Step 204 applies database constraint 151 or 152 respectively to new value 121 or 122. For example, the database constraint may be a column constraint that is a value constraint such as referential, non-nullity, or uniqueness. If the database constraint is satisfied, then step 205 stores the new value from step 203 into one of base columns 126B-127B. For example, step 205 may write new value 121 into key column 126B.

If the database constraint is unsatisfied, then: a) steps 204-205 fail, view write database statement 133 fails and, if a transaction is active, the transaction fails and is rolled back, and b) an error is returned.

### 2.2 View Integrity Scenario B: Security for Semantic Integrity

Scenario B entails steps 206-207 that reject invalid view access database statement 134 as semantically invalid. Step 206 detects that invalid view access database statement 134 references a restricted column. In one example, step 206 detects that invalid view access database statement 134 contains column identifier 146 that identifies key column 126B that is a hidden column. In another example, step 206 detects that invalid view access database statement 134 contains a column identifier of a base column to be written, but the base column is read only or its corresponding view column is read only.

Step 207 responsively rejects invalid view access database statement 134 without executing invalid view access database statement 134 and, for acceleration, without initiating query planning and optimization.

### 2.3 View Integrity Scenario C: Information Hiding

Scenario C entails steps 208-209 that retrieve values from base table 112 through database view 120. Herein, an unreadable view column is hidden or is write only. Without reading an unreadable view column, step 208 executes view wildcard query database statement 132 that does not contain any column identifiers 146-147 of any database columns 126B, 127A, and 127B. For example, view wildcard query database statement 132 may be a structured query language (SQL) SELECT statement that contains a wildcard such as an asterisk (i.e. *) that indicates projection of multiple view columns. Herein, a projection wildcard matches all view columns that are readable. For example, step 209 may return a projection that includes readable view column 127A and excludes unexposed base column 126B.

### 3.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

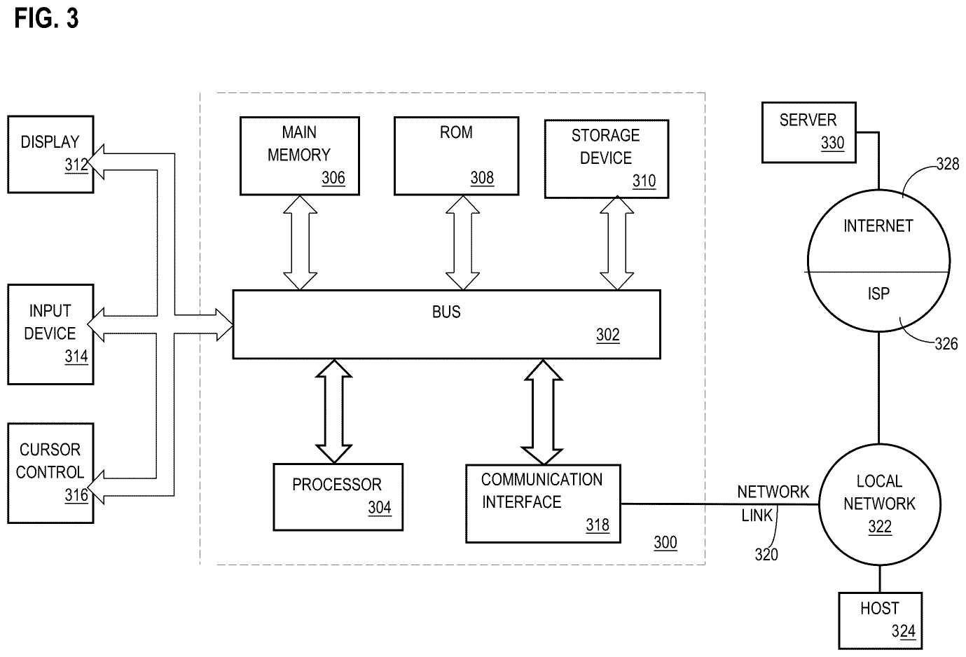

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

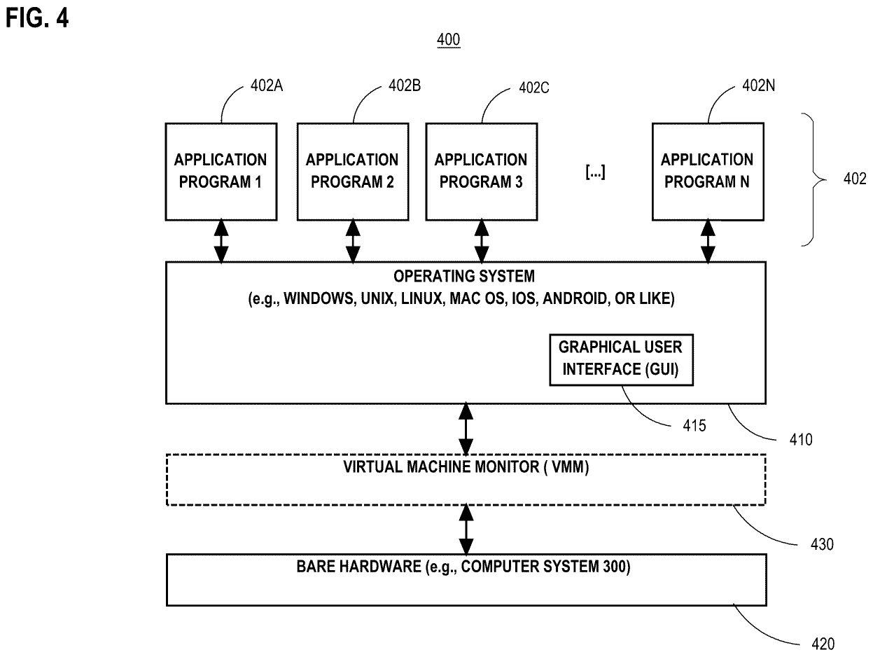

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 400 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
generating a database view by executing a view creation database statement that specifies a value expression for a restricted column in a base table; and
executing a view write database statement including:
evaluating the value expression to generate a new value for the restricted column of a row in the base table, and
storing the new value into the restricted column of the row;
wherein the method is performed by a database server.

2. The method of claim 1 wherein said executing does not cause executing a database trigger.

3. The method of claim 1 wherein the restricted column in the base table is referential.

4. The method of claim 1 wherein the view write database statement does not contain an identifier of the restricted column in the base table.

5. The method of claim 1 wherein:
the database view is unmaterialized and allows writes;
the view creation database statement contains an identifier of a foreign key.

6. The method of claim 1 further comprising without reading the restricted column in the base table, executing a third database statement that contains a wildcard that represents multiple columns of the database view, including returning a projection that is based on the database view.

7. The method of claim 1 further comprising:
detecting that a third database statement contains an identifier of the restricted column in the base table;
rejecting the third database statement in response to said detecting.

8. The method of claim 1 further comprising to the new value, applying a database constraint of the restricted column in the base table.

9. The method of claim 8 wherein the database constraint is referential, non-nullity, or uniqueness.

10. The method of claim 1 wherein said storing is one selected from a group comprising overwriting or writing without overwriting.

11. One or more non-transitory computer-readable media storing instructions that, when executed by a database server, cause:
generating a database view by executing a view creation database statement that specifies a value expression for a restricted column in a base table; and
executing a view write database statement including:
evaluating the value expression to generate a new value for the restricted column of a row in the base table, and
storing the new value into the restricted column of the row.

12. The one or more non-transitory computer-readable media of claim 11 wherein said executing does not cause executing a database trigger.

13. The one or more non-transitory computer-readable media of claim 11 wherein the restricted column in the base table is referential.

14. The one or more non-transitory computer-readable media of claim 11 wherein the view write database statement does not contain an identifier of the restricted column in the base table.

15. The one or more non-transitory computer-readable media of claim 11 wherein:
the database view is unmaterialized and allows writes;
the view creation database statement contains an identifier of a foreign key.

16. The one or more non-transitory computer-readable media of claim 11 wherein the instructions further cause without reading the restricted column in the base table, executing a third database statement that contains a wildcard that represents multiple columns of the database view, including returning a projection that is based on the database view.

17. The one or more non-transitory computer-readable media of claim 11 wherein the instructions further cause:
detecting that a third database statement contains an identifier of the restricted column in the base table;
rejecting the third database statement in response to said detecting.

18. The one or more non-transitory computer-readable media of claim 11 wherein the instructions further cause to the new value, applying a database constraint of the restricted column in the base table.

19. The one or more non-transitory computer-readable media of claim 18 wherein the database constraint is referential, non-nullity, or uniqueness.

20. The one or more non-transitory computer-readable media of claim 11 wherein said storing is one selected from a group comprising overwriting or writing without overwriting.

21. The method of claim 1 wherein said generating comprises in a database schema or a database dictionary, generating a definition of the database view.
